(19) United States
(12) Patent Application Publication
(10) Pub. No.: US 2026/0039107 A1
(43) Pub. Date: Feb. 5, 2026

(54) OVERCURRENT PROTECTION CIRCUIT AND METHOD

(71) Applicant: Dometic Sweden AB, Solna (SE)

(72) Inventors: Xianwen Zhu, Jinwan (CN); Yanxu Wang, Jinwan (CN); Peng Wang, Jinwan (CN)

(21) Appl. No.: 19/099,191

(22) PCT Filed: Jul. 27, 2023
(86) PCT No.: PCT/CN2023/109472

§ 371 Date: Jan. 28, 2025

(30) Foreign Application Priority Data
Jul. 29, 2022 (CN) 202210907469.8

(51) Int. Cl. H02H 7/20; F25B 49/00; F25B 49/02; H02H 1/00

(52) U.S. Cl. CPC H02H 7/20; F25B 49/005; F25B 49/022; H02H 1/0007; F25B 2600/0251; F25B 2700/151

(57) ABSTRACT

The present disclosure relates to an overcurrent protection circuit and an overcurrent protection method, the overcurrent protection circuit and method are implemented through the following steps: sampling a current flowing through the compressor controller and converting the current into a sampling voltage; comparing the sampling voltage with an overcurrent protection threshold, and generating an overcurrent determining signal when the sampling voltage is greater than the overcurrent protection threshold; generating a first trigger signal based on the overcurrent determining signal; generating an overcurrent shutdown signal based on the first trigger signal; shutting down the compressor controller based on the overcurrent shutdown signal; and generating a first setting signal, and locking the overcurrent shutdown signal based on the first setting signal and the first trigger signal, such that the compressor controller is able to be kept shut down, to implement overcurrent protection of the component.

### PRIORITY/INCORPORATION BY REFERENCE

Any and all applications for which a foreign or domestic priority claim is identified in the Application Data Sheet as filed with the present application are hereby incorporated by reference herein and made a part of the present disclosure

### TECHNICAL FIELD

The present disclosure relates to the field of overcurrent protection technologies, and more specifically, to an overcurrent protection circuit and an overcurrent protection method for a compressor controller of a refrigerator.

### BACKGROUND ART

A refrigerator is a commonly used device in daily life to keep food fresh at low temperatures (such as, refrigeration). It mainly achieves a low-temperature environment inside the refrigerator body by controlling the operation of a compressor by using a compressor controller.

However, the compressor may experience a seizure, phase loss, or overpower operation during the operation, which may cause an excessive output current and result in overheating of the compressor controller and burnout of components.

To avoid the overheating and damage of the compressor controller mentioned above, a fuse structure is usually used in an existing refrigerator. In other words, when an overcurrent occurs, a fuse is blown to disconnect a power supply from the compressor controller, so as to stop the operation of the controller. However, the refrigerator using this fuse melting protection mechanism is complex and inconvenient to maintain and has high costs. For example, after disconnection, maintenance operations such as replacing a new fuse need to be performed inside the refrigerator; and additionally, only after a new fuse is installed, the power supply can be restored to restore the normal operation of the component, so as to complete the restart.

### SUMMARY

The technical problem to be solved by the present disclosure is how to provide a protection mechanism for a compressor controller of a refrigerator that implements easy maintenance. To this end, the present disclosure provides a novel overcurrent protection circuit for a compressor controller and an overcurrent protection method.

According to a first aspect of the present disclosure, there is provided an overcurrent protection circuit, where a power supply is connected to a compressor controller of a refrigerator via the overcurrent protection circuit, where the overcurrent protection circuit includes:
a switch module configured to disconnect the power supply from and connect the power supply to the compressor controller;
a sampling module that samples a current flowing through the compressor controller and converts the current into a sampling voltage;
a reference module that provides a reference voltage to set an overcurrent protection threshold;
a determining module that compares the sampling voltage with the reference voltage, where when it is determined that the sampling voltage is greater than the reference voltage, a determining signal outputted by the determining module transitions to an overcurrent determining signal;
a determining signal control module that includes a trigger element and a switch element, where the trigger element receives the overcurrent determining signal and generates a first trigger signal based on the overcurrent determining signal, and the switch element receives the first trigger signal and generates an overcurrent shutdown signal based on the first trigger signal, where the determining signal control module further includes a signal control element;
a switch control module that controls, based on the overcurrent shutdown signal, the switch module to disconnect the power supply from the compressor controller; and
a setting module that provides a first setting signal, where the signal control element locks the overcurrent shutdown signal based on the first setting signal and the first trigger signal, such that the power supply is able to be kept disconnected from the compressor controller, so as to shut down the compressor controller.

According to the overcurrent protection circuit for a compressor controller in the first aspect of the present disclosure, a fuse structure in an existing refrigerator is replaced, information of the compressor controller is collected and compared with reference information, and power supplied by the power supply to the compressor controller can be cut off by using the switch module in the circuit based on a comparison determining result of overcurrent information, so as to protect components (prevent the components from overheating and burning out). Therefore, overcurrent information is detected through the circuit and the electrical connection is cut off, which avoids a need for corresponding maintenance operations (such as replacing a new fuse) after the fuse is blown, thereby simplifying/reducing the complexity and cost of maintenance (and even eliminating the need for maintenance).

In addition, the overcurrent protection circuit according to the first aspect of the present disclosure may further have the following additional technical features:

according to an aspect of the present disclosure, when the compressor controller requires to be restarted: the refrigerator is completely powered off and then powered on again; the setting module provides a second setting signal; the determining module is able to determine, when the compressor controller is in a shutdown state, that the reference voltage is greater than the sampling voltage, and the determining module outputs an operation determining signal, where the signal control element cooperates, based on the second setting signal, with the trigger element that receives the operation determining signal, such that the trigger element generates a second trigger signal, the switch element receives the second trigger signal and releases, based on the second trigger signal, the lock on the output of the overcurrent shutdown signal, so as to output an operation conduction signal, and the switch control module controls, based on the operation conduction signal, the switch module to connect the power supply to the compressor controller, so as to restore the operation of the compressor controller; and after the compressor controller is restarted, the setting module changes to providing a first setting signal.

When a restart is required, the connection between the power supply and the compressor controller can be reestablished through the overcurrent protection circuit according to this aspect of the present disclosure simply by powering off the refrigerator completely and then powering it on again, thereby restoring the operation of the compressor controller and further restoring the normal operation of the refrigerator. Therefore, it is easier to restart the refrigerator by directly reestablishing the electrical connection through the circuit.

According to an aspect of the present disclosure, the overcurrent protection circuit further includes an automatic restart control module, the automatic restart control module includes a first port and a second port, and the first port detects output of the switch element, where when the first port detects an overcurrent shutdown signal outputted by the switch element and the signal has been outputted for a period of time: the second port of the automatic restart control module is able to provide a restart control signal; the determining module is able to determine, when the compressor controller is in a shutdown state, that the reference voltage is greater than the sampling voltage, and the determining module outputs an operation determining signal, where the signal control element cooperates, based on the restart control signal, with the trigger element that receives the operation determining signal, such that the trigger element generates a second trigger signal, the switch element receives the second trigger signal and releases, based on the second trigger signal, the lock on the output of the overcurrent shutdown signal, so as to output an operation conduction signal, and the switch control module controls, based on the operation conduction signal, the switch module to connect the power supply to the compressor controller, so as to restore the operation of the compressor controller; and after the compressor controller is restarted, the second port of the automatic restart control module causes the setting module to continue to provide a first setting signal.

After the refrigerator has been stopped for a period of time, the overcurrent protection circuit according to this aspect of the present disclosure can automatically reestablish the connection between the power supply and the compressor controller, thereby automatically restoring the operation of the compressor controller and further automatically restoring the normal operation of the refrigerator. Therefore, the complexity and cost of maintenance can be further simplified/reduced by automatically reestablishing the electrical connection through the circuit.

According to an aspect of the present disclosure, the determining signal control module is a gate combination circuit, where the trigger element is a first NAND gate circuit, the signal control element is a second NAND gate circuit, and the switch element is a third NAND gate circuit, where a second input terminal of the first NAND gate circuit is connected to an output terminal of the determining module as an input terminal of the determining signal control module, and a first input terminal of the first NAND gate circuit is connected to an output terminal of the second NAND gate circuit; a second input terminal of the second NAND gate circuit is connected to an output terminal of the first NAND gate circuit, and a first input terminal of the second NAND gate circuit is connected to the setting module; and a first input terminal and a second input terminal of the third NAND gate circuit are both connected to the output terminal of the first NAND gate circuit, and an output terminal of the third NAND gate circuit is used as an output terminal of the determining signal control module.

According to an aspect of the present disclosure, the setting module includes a first voltage dividing resistor and a capacitor that are connected in series, where one terminal of the first voltage dividing resistor is connected to a positive electrode of the power supply, one terminal of the capacitor is connected to a negative electrode of the power supply, and a common connection terminal of the first voltage dividing resistor and the capacitor is connected to the signal control element.

According to an aspect of the present disclosure, the switch module is an N-MOSFET, and the sampling module is a current sampling resistor, where a drain of the N-MOSFET is connected to a power supply negative electrode input terminal of the compressor controller, a source of the N-MOSFET is connected to one terminal of the current sampling resistor, and a gate of the N-MOSFET is connected to the switch control module, where the other terminal of the current sampling resistor is connected to a negative electrode of the power supply; the reference module includes a second voltage dividing resistor and a third voltage dividing resistor that are connected in series, where one terminal of the first voltage dividing resistor is connected to a positive electrode of the power supply, and one terminal of the second voltage dividing resistor is connected to the negative electrode of the power supply; and the determining module is a comparator circuit, where a positive input terminal of the comparator circuit is connected to a common connection terminal of the first voltage dividing resistor and the second voltage dividing resistor, and a negative input terminal of the comparator circuit is connected to a common connection terminal of the N-MOSFET and the current sampling resistor.

According to an aspect of the present disclosure, the switch control module includes a first NPN transistor and a second NPN transistor, where a base of the first NPN transistor is connected to an output terminal of the determining signal control module, a collector of the first NPN transistor is connected to the positive electrode of the power supply via a pull-up resistor, and an emitter of the first NPN transistor is connected to the negative electrode of the power supply; and a base of the second NPN transistor is connected to the collector of the first NPN transistor, a collector of the second NPN transistor is connected to the positive electrode of the power supply via a pull-up resistor, and an emitter of the second NPN transistor is connected to the negative electrode of the power supply, where the collector of the second NPN transistor is connected to a gate of the switch module.

According to an aspect of the present disclosure, the switch control module includes a first NPN transistor and a second PNP transistor, where a base of the first NPN transistor is connected to an output terminal of the determining signal control module, a collector of the first NPN transistor is connected to the positive electrode of the power supply via a pull-up resistor, and an emitter of the first NPN transistor is connected to the negative electrode of the power supply; a base of the second PNP transistor is connected to the collector of the first NPN transistor, an emitter of the second PNP transistor is connected to the positive electrode of the power supply, and a collector of the second PNP transistor is connected to a gate of the switch module via a current limiting resistor.

According to an aspect of the present disclosure, the switch module includes a P-MOSFET, where a source of the P-MOSFET is connected to a positive electrode of the power supply, a drain of the P-MOSFET is connected to a power supply positive electrode input terminal of the compressor controller, and a gate of the P-MOSFET is connected to the switch control module; the sampling module is a current sampling resistor connected between a power supply negative electrode input terminal of the compressor controller and a negative electrode of the power supply; the reference module includes a second voltage dividing resistor and a third voltage dividing resistor that are connected in series, where one terminal of the second voltage dividing resistor is connected to a positive electrode of the power supply, and one terminal of the third voltage dividing resistor is connected to the negative electrode of the power supply; and the determining module is a comparator circuit, where a positive input terminal of the comparator circuit is connected to a common connection terminal of the second voltage dividing resistor and the third voltage dividing resistor, and a negative input terminal of the comparator circuit is connected between the current sampling resistor and the power supply negative electrode input terminal of the compressor controller.

According to an aspect of the present disclosure, the switch control module includes a first NPN transistor, a base of the first NPN transistor is connected to an output terminal of the determining signal control module, a collector of the first NPN transistor is connected to a gate of the switch module via a current limiting resistor, an emitter of the first NPN transistor is connected to a negative electrode of the power supply, and the gate of the switch module is connected to the positive electrode of the power supply via a current limiting circuit.

According to a second aspect of the present disclosure, there is provided an overcurrent protection method for protecting a compressor controller of a refrigerator, including the following steps:
sampling a current flowing through the compressor controller and converting the current into a sampling voltage;
comparing the sampling voltage with an overcurrent protection threshold, and generating an overcurrent determining signal when the sampling voltage is greater than the overcurrent protection threshold;
generating a first trigger signal based on the overcurrent determining signal;
generating an overcurrent shutdown signal based on the first trigger signal;
shutting down the compressor controller based on the overcurrent shutdown signal; and
generating a first setting signal, and locking the overcurrent shutdown signal based on the first setting signal and the first trigger signal, such that the compressor controller is able to be kept shut down.

According to an aspect of the present disclosure, when the compressor controller requires to be restarted, the method includes the following steps: powering off the entire refrigerator and then powering it on again; generating a second setting signal; when the compressor controller is in a shutdown state, generating an operation determining signal when it is able to determine by comparison that the reference voltage is greater than the sampling voltage; generating a second trigger signal based on the second setting signal and the operation determining signal; releasing the lock on the output of the overcurrent shutdown signal based on the second trigger signal, so as to output an operation conduction signal; restoring the operation of the compressor controller based on the operation conduction signal; and changing to generating a first setting signal after the compressor controller is restarted.

According to an aspect of the present disclosure, the method further includes the following steps: detecting an overcurrent shutdown signal and that the signal has been outputted for a period of time; generating a restart control signal; when the compressor controller is in a shutdown state, outputting an operation determining signal when it is able to determine by comparison that the reference voltage is greater than the sampling voltage; generating a second trigger signal based on the restart control signal and the operation determining signal; releasing the lock on the output of the overcurrent shutdown signal based on the second trigger signal, so as to output an operation conduction signal; restoring the operation of the compressor controller based on the operation conduction signal; and changing to continuing to generate a first setting signal after the compressor controller is restarted.

### BRIEF DESCRIPTION OF THE DRAWINGS

The present disclosure will be further explained below in conjunction with the accompanying drawings and embodiments. In the accompanying drawings:

FIG. 1 is a schematic block diagram of function modules of an overcurrent protection circuit according to the first aspect of the present disclosure, where a functional relationship between the circuit, a power supply, and a compressor controller is generally represented;

FIG. 2A is a circuit diagram of a first implementation of an overcurrent protection circuit according to the first aspect of the present disclosure, where a connection relationship between the circuit, a power supply, and a compressor controller is generally represented;

FIG. 2B is a circuit diagram of a second implementation of an overcurrent protection circuit according to the first aspect of the present disclosure, where a connection relationship between the circuit, a power supply, and a compressor controller is generally represented;

FIG. 2C is a circuit diagram of a third implementation of an overcurrent protection circuit according to the first aspect of the present disclosure, where a connection relationship between the circuit, a power supply, and a compressor controller is generally represented;

FIG. 3 is a schematic block diagram of function modules of an overcurrent protection circuit having an automatic restart control module according to the first aspect of the present disclosure, where a functional relationship between the circuit, a power supply, and a compressor controller is generally represented;

FIG. 4A is a circuit diagram of a first implementation of an overcurrent protection circuit having an automatic restart control module according to the first aspect of the present disclosure, where a connection relationship between the circuit, a power supply, and a compressor controller is generally represented;

FIG. 4B is a circuit diagram of a second implementation of an overcurrent protection circuit having an automatic restart control module according to the first aspect of the present disclosure, where a connection relationship between the circuit, a power supply, and a compressor controller is generally represented;

FIG. 4C is a circuit diagram of a third implementation of an overcurrent protection circuit having an automatic restart control module according to the first aspect of the present disclosure, where a connection relationship between the circuit, a power supply, and a compressor controller is generally represented;

FIG. 5 is a flowchart of an overcurrent protection method according to the second aspect of the present;

FIG. 6 is a flowchart of an overcurrent protection method according to the second aspect of the present; and

FIG. 7 is a flowchart of an overcurrent protection method according to the second aspect of the present disclosure.

### DETAILED DESCRIPTION OF EMBODIMENTS

Embodiments of the present disclosure will be described below in detail, and examples of the embodiments are shown in the drawings, where the same or similar reference signs represent the same or similar elements or the elements having the same or similar functions. The embodiments described below with reference to the drawings are exemplary and are intended to be illustrative of the present disclosure, but should not be construed as limiting the present disclosure.

In order to make the objectives, technical solutions, and advantages of the present disclosure clearer and more comprehensible, the present disclosure is further described in detail below with reference to the accompanying drawings.

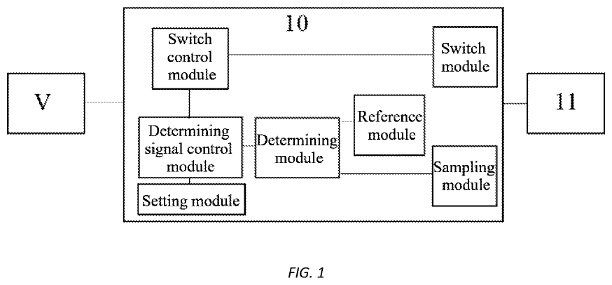

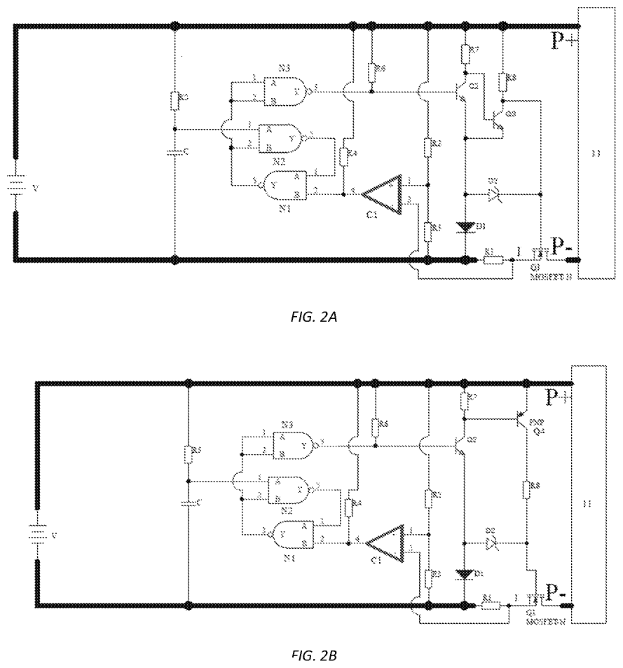

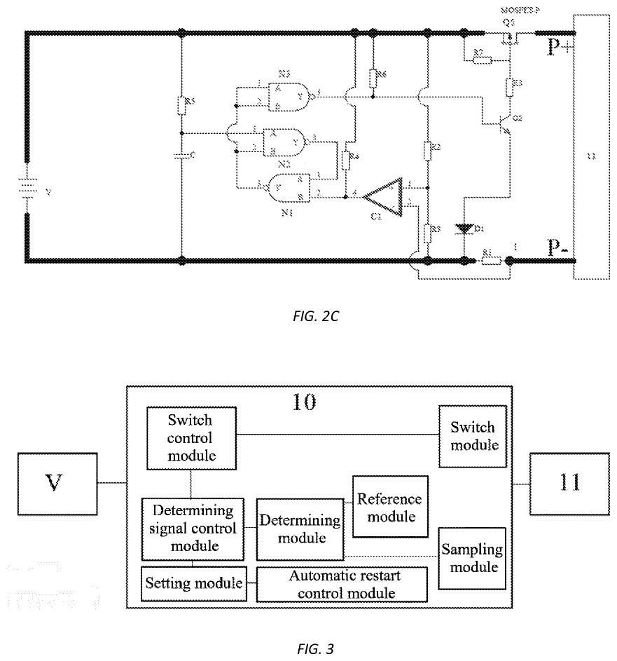

Referring to FIGS. 1 and 2A, in an overcurrent protection circuit 10 of the first implementation, as an example, a switch module is an N-MOSFET Q1, a sampling module is a current sampling resistor R1, a reference module includes a second voltage dividing resistor R2 and a third voltage dividing resistor R3, a determining module is a comparator circuit C1, a determining signal control module is a gate combination circuit including three NAND gate circuits N1 to N3, a setting module includes a first voltage dividing resistor R5 and a capacitor C, and a switch control module includes a first NPN transistor Q2 and a second NPN transistor Q3.

Structures of and a connection relationship between related main modules in the overcurrent protection circuit according to the first implementation of the present disclosure are further described below with reference to FIGS. 1 and 2A. A power supply V is connected to a compressor controller 11 of a refrigerator via the overcurrent protection circuit 10, where a P+ terminal and a P− terminal of the overcurrent protection circuit 10 are connected to a power supply positive electrode input terminal and a power supply negative electrode input terminal of the compressor controller, respectively. A drain of the N-MOSFET Q1, which is used as the switch module, is connected to the power supply negative electrode input terminal of the compressor controller 11, a source of the N-MOSFET Q1 is connected to one terminal of the current sampling resistor R1, while the other terminal of the current sampling resistor R1 is connected to a negative electrode of the power supply V. The two voltage dividing resistors R2 and R3 forming the reference module are connected in series between the positive electrode and the negative electrode of the power supply V. A positive input terminal of the comparator circuit C1 is connected to a common connection terminal of the voltage dividing resistors R2 and R3, a negative input terminal of the comparator circuit C1 is connected to a common connection terminal of the N-MOSFET Q1 and the current sampling resistor R1, and an output terminal of the comparator circuit C1 is connected to a second input terminal B of the first NAND gate circuit N1. A first input terminal A of the first NAND gate circuit is connected to an output terminal Y of the second NAND gate circuit N2. A second input terminal B of the second NAND gate circuit N2 is connected to an output terminal Y of the first NAND gate circuit N1, and a first input terminal A of the second NAND gate circuit N2 is connected to a common connection terminal of the first voltage dividing resistor R5 and the capacitor C (which are connected in series between the positive electrode and the negative electrode of the power supply V). A first input terminal A and a second input terminal B of the third NAND gate circuit N3 are both connected to the output terminal Y of the first NAND gate circuit N1, an output terminal Y of the third NAND gate circuit N3 is connected to a base of the first NPN transistor Q2, a collector of the first NPN transistor Q2 is connected to the positive electrode of the power supply V via a pull-up resistor R7, and an emitter of the first NPN transistor Q2 is connected to the negative electrode of the power supply V. A base of the second NPN transistor Q3 is connected to the collector of the first NPN transistor Q2, a collector of the second NPN transistor Q3 is connected to the positive electrode of the power supply V via a pull-up resistor R8, an emitter of the second NPN transistor Q3 is connected to the negative electrode of the power supply V (for example, the emitters of Q2 and Q3 are connected together and then connected to the negative electrode of the power supply), and the collector of the second NPN transistor Q3 is also connected to a gate of the N-MOSFET Q1.

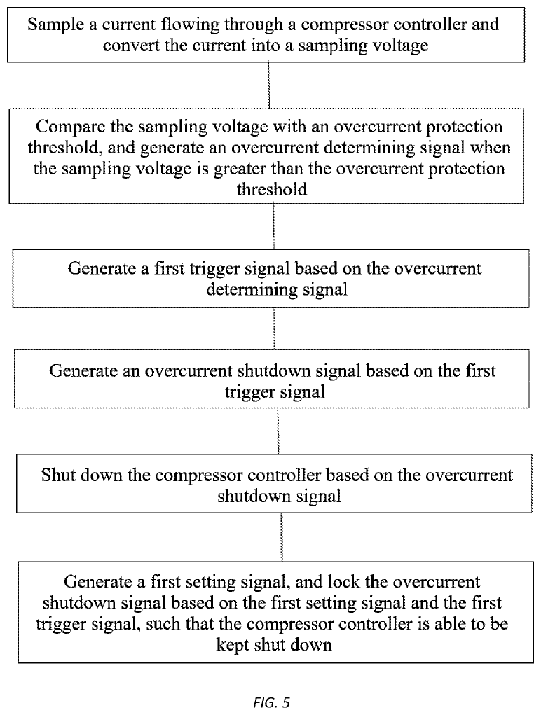

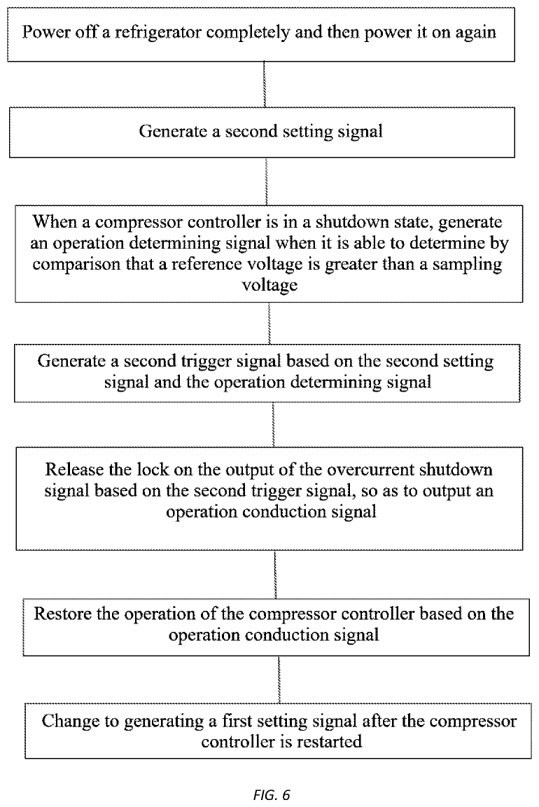

Referring to FIG. 5 and FIG. 6, a specific working principle of the first implementation of the overcurrent protection circuit shown in FIG. 2A is as follows.

The current sampling resistor RI samples a current I flowing through the compressor controller 11, and converts it into a sampling voltage V_{sampling} through I×R1, where the sampling voltage V_{sampling} is used as an input of the negative input terminal of the comparator circuit C1. The resistors R2 and R3 that form the reference module provide, through a voltage dividing function, a reference voltage_{reference}=(R3/R2+R3)V (that is, an overcurrent protection threshold) as an input of the positive input terminal of the comparator circuit C1. However, when the compressor experiences a seizure, phase loss, or overpower operation, resulting in an excessive current (that is, overcurrent), the sampling voltage V_{sampling} will be greater than the reference voltage V_{reference}, and the comparator circuit C1 outputs a low level signal (for example, a digital signal “0”), that is, an overcurrent determining signal, based on a comparison determining result of V_{sampling}>V_{reference}. The second input terminal B of the first NAND gate circuit N1 receives the overcurrent determining signal (that is, the low level signal) outputted by the comparator circuit, and the output terminal Y of the first NAND gate circuit generates/outputs a high level signal (for example, a digital signal “1”), which is a first trigger signal. The first input terminal A and the second input terminal B of the third NAND gate circuit N3 both receive the first trigger signal (that is, the high level signal), and the output terminal Y of the third NAND gate circuit generates/outputs a low level signal (that is, an overcurrent shutdown signal). The first NPN transistor Q2 is not turned on because the base of the first NPN transistor receives the low level signal generated/outputted by the output terminal Y of the third NAND gate circuit N3, which causes the second NPN transistor Q3 to be turned on, resulting in the gate of the N-MOSFET Q1 being pulled to a low level and the N-MOSFET thus being not turned on, and because Q1 is not turned on, the connection between the power supply V and the compressor controller 11 is cut off. The second input terminal B of the second NAND gate circuit N2 receives the high level signal outputted by the first NAND gate circuit N1, the first input terminal of the second NAND gate circuit receives a high level signal (that is, a first setting signal) provided by the resistor R5 and the capacitor C, through a voltage dividing function thereof, that form the setting module. The second NAND gate circuit N2 thus outputs a low level signal to the first input terminal A of the first NAND gate circuit N1, to lock the output of the third NAND gate circuit N3 as a low level signal (that is, an overcurrent shutdown signal) to keep the disconnection between the power supply V and the compressor controller 11 (which is to avoid a case that the overcurrent shutdown signal cannot be continuously outputted because there is an immediate transition of a determining signal back to a high level signal due to that the reference voltage is greater than the sampling voltage after the disconnection), thereby achieving the purpose of protecting the compressor controller.

According to the overcurrent protection circuit for a compressor controller in this implementation, whether there is an overcurrent is determined by comparing the sampling voltage with the reference voltage; and when it is determined that the sampling voltage is greater than the reference voltage (that is, there is an overcurrent), an overcurrent determining signal is generated/outputted, an overcurrent shutdown signal is generated/outputted based on the overcurrent determining signal, and the overcurrent shutdown signal is locked to continuously shut down the compressor controller, thereby achieving the purpose of protecting the compressor controller. Therefore, a fuse mechanism in an existing refrigerator is replaced by detecting an overcurrent and cutting off the electrical connection through the circuit of the present disclosure, which may avoid a need for maintenance operations (such as replacing a new fuse) after the fuse is blown, thereby simplifying/reducing the complexity and cost of maintenance (and even eliminating the need for maintenance).

However, the compressor controller can be restarted after the fault is eliminated (for example, after stopped operation for a period of time). Specifically, the refrigerator is completely powered off and then powered on again, and the resistor R5 and the capacitor C that form the setting module are powered on again, where the capacitor C is first charged, and the capacitor C may be considered, during the charging, as providing a low level signal (that is, a second setting signal) to the first input terminal A of the second NAND gate circuit N2, such that the output terminal Y of the second NAND gate circuit N2 outputs a high level signal to the first input terminal A of the first NAND gate circuit N1 (which may release the lock on the overcurrent shutdown signal). When the compressor controller is in a shutdown state, the comparator circuit C1 can determine by comparison that the reference voltage is greater than the sampling voltage, the comparator circuit thus outputs a high level signal (that is, an operation determining signal). Because the first input terminal A of the first NAND gate circuit N1 receives the high level signal outputted by the second NAND gate circuit N2 and the second input terminal B of the first NAND gate circuit receives the high level signal outputted by the comparator circuit, the output terminal Y of the first NAND gate circuit N1 thus outputs a low level signal (that is, a second trigger signal). The first input terminal A and the second input terminal B of the third NAND gate circuit N3 both receive the second trigger signal, and the output terminal Y of the third NAND gate circuit thus generates/outputs an operation conduction signal (that is, a high level signal). The first NPN transistor Q2 is turned on because the base of the first NPN transistor receives the high level signal generated/outputted by the output terminal Y of the third NAND gate circuit N3, which causes the second NPN transistor Q3 not to be turned on, resulting in the gate of the N-MOSFET Q1 being pulled to a high level and the N-MOSFET thus being turned on, and because Q1 is turned on, the power supply V is reconnected to the compressor controller 11, thereby restoring the operation of the compressor controller and the refrigerator. The charging process of the capacitor C may, for example, last for about 100 milliseconds, so as to ensure that the second NAND gate circuit N2 can receive the low level signal (that is, the second setting signal) to release the lock on the overcurrent shutdown signal outputted by the third NAND gate circuit N3, such that the output of the third NAND gate circuit N3 may follow a change of the output of the comparator circuit C1 to change to entering a time period of an operation conduction signal, but after the restart and the completion of the charging process of the capacitor, due to a voltage dividing function of the resistor R5 and the capacitor C of the setting module, the third NAND gate circuit changes to providing the high level signal (that is, the first setting signal) to the first input terminal A of the second NAND gate circuit N2, thereby ensuring that the third NAND gate circuit can continuously output an operation conduction signal when the comparator circuit continuously output an operation determining signal during normal operation, and that the output of the third NAND gate circuit can transition to an overcurrent shutdown signal and be locked when the output of the comparator circuit transitions to an overcurrent determining signal when an overcurrent occurs.

When a refrigerator having the overcurrent protection circuit according to this implementation requires to be restarted, the connection between the power supply and the compressor controller can be reestablished through the overcurrent protection circuit simply by powering off the refrigerator completely and then powering it on again, thereby restoring the operation of the compressor controller and further restoring the normal operation of the refrigerator. Therefore, the electrical connection is directly reestablished through the overcurrent protection circuit according to this implementation, which avoids a need for operations of replacing a fuse before the restart, thereby making it easier to restart the refrigerator.

Additionally or alternatively, in the first implementation, a diode D1 may be optionally connected between the emitter of the first NPN transistor Q2, the emitter of the second NPN transistor Q3, and the negative electrode of the power supply V. The diode D1 can protect the circuit in case of an accidental reverse connection of the input terminal. Additionally or alternatively, in the first implementation, a voltage stabilizing diode D2 may be connected to the gate of the N-MOSFET Q1 to stabilize a voltage at the gate.

Referring to FIGS. 1 and 2B, a difference between the overcurrent protection circuit 10 in the second implementation and that in the first implementation lies in a specific structure of a switch control module, where as an example, the switch control module includes a first NPN transistor Q2 and a second PNP transistor Q4. Structures and a specific connection relationship of the other modules in this implementation are basically the same as those of the other modules in the first implementation and will not be repeated here. Only a structure of the different switch control module and a connection relationship between the switch control module and the other parts are described in detail. Specifically, the switch control module includes a first NPN transistor Q2 and a second PNP transistor Q4, a base of the first NPN transistor Q2 is connected to the output terminal Y of the third NAND gate circuit N3, a collector of the first NPN transistor is connected to the positive electrode of the power supply V via a pull-up resistor R7, and an emitter of the first NPN transistor is connected to the negative electrode of the power supply V. A base of the second PNP transistor Q4 connected to the collector of the first NPN transistor Q2, an emitter of the second PNP transistor Q4 is connected to the positive electrode of the power supply V, and a collector of the second PNP transistor Q4 is connected to the gate of the switch module N-MOSFET Q1 via a current limiting resistor R8.

A working principle of the overcurrent protection circuit of the second implementation shown in FIG. 2B is basically similar to the working principle of the overcurrent protection circuit of the first implementation shown in FIG. 2A, and a difference lies in a working principle of the different switch control module. The working principle of the switch control module is as follows: When an overcurrent is detected, the first NPN transistor Q2 is not turned on because the base of the first NPN transistor receives the low level signal (that is, the overcurrent shutdown signal) generated/outputted by the third NAND gate circuit N3, which causes the second PNP transistor Q4 not to be turned on, resulting in the gate of the N-MOSFET Q1 being pulled to a low level and the N-MOSFET thus being not turned on, and if Q1 is not turned on, the power supply V is disconnected from the compressor controller 11. When a restart is required, the first NPN transistor Q2 is turned on because the base of the first NPN transistor receives the high level signal (that is, the operation conduction signal) generated/outputted by the output terminal Y of the third NAND gate circuit N3, which causes the second PNP transistor Q4 to be turned on, resulting in the gate of the N-MOSFET Q1 being pulled to a high level and the N-MOSFET thus being turned on, and if Q1 is turned on, the power supply V is reconnected to the compressor controller 11.

Additionally or alternatively, in the second implementation, a diode D1 may be optionally connected between the emitter of the first NPN transistor Q2 and the negative electrode of the power supply V. The diode D1 can protect the circuit in case of an accidental reverse connection of the input terminal. Additionally or alternatively, in the second implementation, a voltage stabilizing diode D2 may be connected to the gate of the N-MOSFET Q1 to stabilize a voltage at the gate.

Referring to FIGS. 1 and 2C, a difference between the overcurrent protection circuit 10 in the third implementation and that in the first implementation lies in specific structures of a switch control module and a switch module, where as an example, the switch control module includes a first NPN transistor Q2, and the switch module includes a P-MOSFET Q5. Structures and a specific connection relationship of the other modules in this implementation are basically the same as those of the other modules in the first implementation and will not be repeated here, and only structures of the different switch control module and switch module and a connection relationship between the switch control module, the switch module, and the other parts are described in detail. Specifically, the switch control module includes a first NPN transistor Q2, a base of the first NPN transistor Q2 is connected to the output terminal Y of the third NAND gate circuit N3, a collector of the first NPN transistor is connected to a gate of the P-MOSFET Q5 via a current limiting resistor R8, an emitter of the first NPN transistor is connected to the negative electrode of the power supply V, a source of the P-MOSFET Q5 is connected to the positive electrode of the power supply V, a drain of the P-MOSFET is connected to the power supply positive input terminal of the compressor controller, and the gate of the P-MOSFET is also connected to the positive electrode of the power supply V via a current limiting resistor R7.

A working principle of the overcurrent protection circuit of the third implementation shown in FIG. 2C is basically similar to the working principle of the overcurrent protection circuit of the first implementation shown in FIG. 2A, and a difference lies in a working principle of the different switch control module and switch module. The working principle of the switch control module and the switch module is as follows: When an overcurrent is detected, the first NPN transistor Q2 is not turned on because the base of the first NPN transistor receives the low level signal (that is, the overcurrent shutdown signal) generated/outputted by the third NAND gate circuit N3, resulting in the gate of the P-MOSFET Q5 being pulled to a high level and the P-MOSFET thus being not turned on, and if Q5 is not turned on, the power supply V is disconnected from the compressor controller 11. When a restart is required, the first NPN transistor Q2 is turned on because the base of the first NPN transistor receives the high level signal (that is, the operation conduction signal) generated/outputted by the output terminal Y of the third NAND gate circuit N3, resulting in the gate of the P-MOSFET Q5 being pulled to a low level and the P-MOSFET thus being turned on, and if Q5 is turned on, the power supply V is reconnected to the compressor controller 11.

Additionally or alternatively, in the second implementation, a diode D1 may be optionally connected between the emitter of the first NPN transistor Q2 and the negative electrode of the power supply V. The diode D1 can protect the circuit in case of an accidental reverse connection of the input terminal.

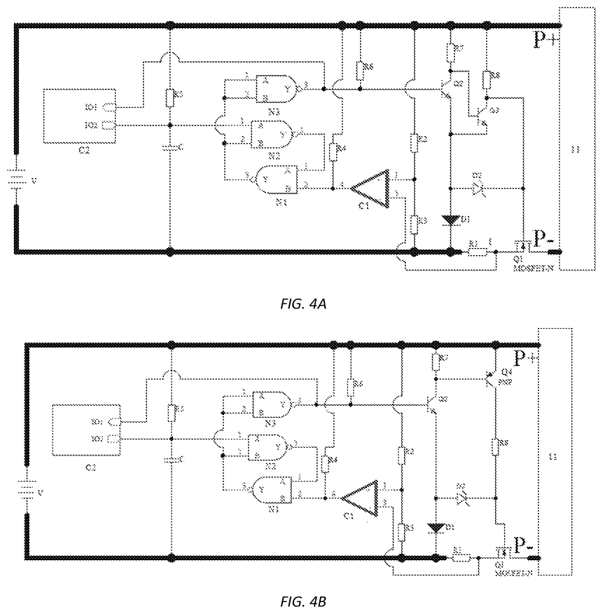

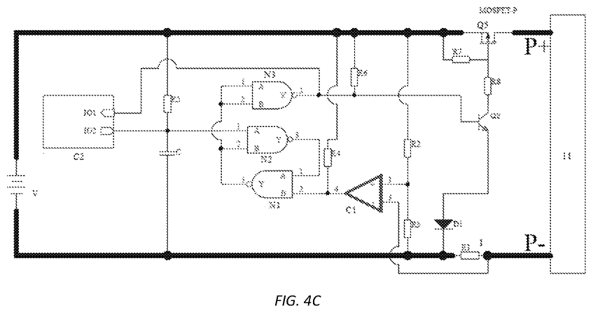

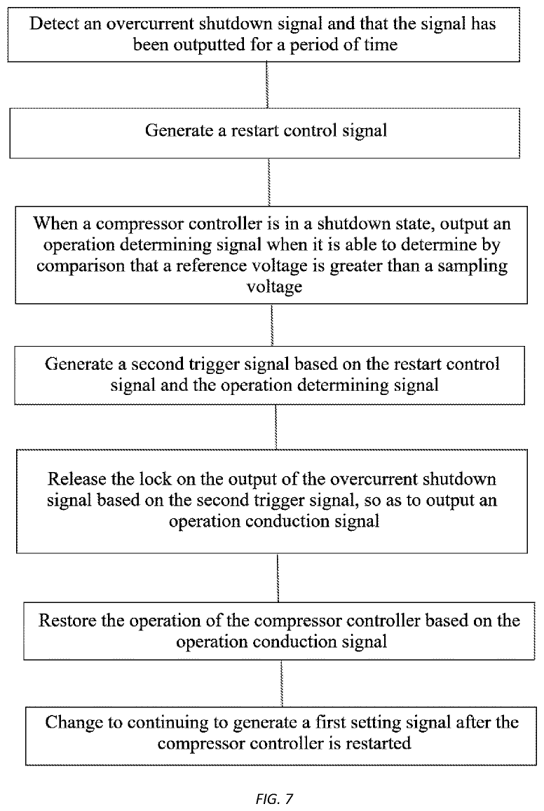

Structures, a connection relationship, and a working principle of related main modules in an overcurrent protection circuit having an automatic restart control module C2 according to the present disclosure are described below with reference to FIG. 3, FIGS. 4A to 4C, and FIG. 7. A difference between the overcurrent protection circuit shown in FIGS. 4A to 4C and the overcurrent protection circuit shown in FIGS. 2A to 2C lies in that the former has an automatic restart control module. Therefore, structures, a specific connection relationship, and an overcurrent protection working principle of the other modules of the implementation of FIGS. 4A to 4C are basically the same as those of the other modules of the implementation of FIGS. 2A to 2C and are thus not repeated again, and only a structure of the automatic restart control module C2, a connection relationship between the automatic restart control module and the other modules, and a restart working principle are described in detail. Specifically, the automatic restart control module C2 includes a first port IO1 and a second port IO2, the first port IO1 is connected to the output terminal Y of the third NAND gate circuit N3, and the second port IO2 is connected to the first input terminal A of the second NAND gate circuit N2 (actually, it may also be considered as being connected to the common connection terminal of the resistor R5 and the capacitor C). An automatic restart working principle is as follows: The first port IO1 can be used to detect the output of the third NAND gate circuit N3. When the automatic restart control module detects, via the first port, a low level signal (that is, an overcurrent shutdown signal) outputted by the third NAND gate circuit N3 and the signal has been outputted for a period of time, the automatic restart control module may, for example, connect the first input terminal A of the second NAND gate circuit N2 to the negative electrode of the power supply via the second port IO2 (for example, similar to a switch), so as to provide a low level signal (that is, provide a restart control signal) to the first input terminal A, causing the output terminal Y of the second NAND gate circuit N2 to output a high level signal to the first input terminal A of the first NAND gate circuit N1 (which may release the lock on the overcurrent shutdown signal). When the compressor controller is in a shutdown state, the comparator circuit C1 can determine by comparison that the reference voltage is greater than the sampling voltage, the comparator circuit thus outputs a high level signal (that is, an operation determining signal). Because the first input terminal A of the first NAND gate circuit N1 receives a high level signal outputted by the second NAND gate circuit N2 and the second input terminal B of the first NAND gate circuit receives the high level signal outputted by the comparator circuit, the output terminal Y of the first NAND gate circuit N1 thus outputs a low level signal (that is, a second trigger signal). The first input terminal A and the second input terminal B of the third NAND gate circuit N3 both receive the second trigger signal, and the output terminal Y of the third NAND gate circuit thus generates/outputs an operation conduction signal (that is, a high level signal). The switch control module may control, based on the operation conduction signal (in a manner the same as that described above with reference to FIGS. 2A to 2C), the switch module to connect the power supply to the compressor controller, thereby restoring the operation of the compressor controller and the refrigerator. A time for the automatic restart control module to connect, via the second port IO2, the first input terminal A of the second NAND gate circuit N2 to the negative electrode of the power supply may, for example, last for about 100 milliseconds, so as to ensure that the second NAND gate circuit N2 can receive the low level signal (that is, the restart control signal) to release the lock on the overcurrent shutdown signal outputted by the third NAND gate circuit N3, such that the output of the third NAND gate circuit N3 may follow a change of the output of the comparator circuit C1 to change to entering a time period of an operation conduction signal. However, after the restart is completed (for example, after the 100 milliseconds or a specific period of time elapses after the operation conduction signal is detected by the first port), the automatic restart control module may connect, via the second port 102, the first input terminal A of the second NAND gate circuit N2 to the common connection terminal of the resistor R5 and the capacitor C, so as to change to providing a high level signal (that is, a first setting signal) to the first input terminal A of the second NAND gate circuit N2, thereby ensuring that the third NAND gate circuit can continuously output an operation conduction signal when the comparator circuit continuously outputs an operation determining signal during normal operation, and that the output of the third NAND gate circuit can transition to an overcurrent shutdown signal and be locked when the output of the comparator circuit transitions to an overcurrent determining signal when an overcurrent occurs.

After the refrigerator has been stopped for a period of time, the overcurrent protection circuit having an automatic restart control module according to the present disclosure can automatically reestablish the connection between the power supply and the compressor controller, thereby automatically restoring the operation of the compressor controller and further automatically restoring the normal operation of the refrigerator. Therefore, the complexity and cost of maintenance can be further simplified/reduced by automatically reestablishing the electrical connection through the circuit, and the restart of the refrigerator is more convenient.

Additionally or alternatively, in an optional example of the overcurrent protection circuit according to the first aspect of the present disclosure, the output terminal Y of the comparator circuit C1 and the output terminal Y of the third NAND gate circuit N3 may be optionally connected to the positive electrode of the power supply via pull-up resistors R4 and R6, respectively.

According to a second aspect of the present disclosure, there is further provided an overcurrent protection method, for example, including the following overcurrent protection steps (referring to FIG. 5).

A current flowing through the compressor controller is sampled and converted into a sampling voltage. For example, the current I flowing through the compressor controller is sampled by using a current sampling resistor R1, and is converted into a sampling voltage V sampling through I×R1.

The sampling voltage is compared with an overcurrent protection threshold, and an overcurrent determining signal is generated when the sampling voltage is greater than the overcurrent protection threshold. For example, the sampling voltage can be compared with the threshold voltage by using a comparator circuit, and when it is determined by comparison that the sampling voltage is greater than the threshold voltage, a low level signal is provided as an overcurrent determining signal.

A first trigger signal is generated based on the overcurrent determining signal. For example, one of input terminals of a first NAND gate circuit in a gate combination circuit receives the overcurrent determining signal, so as to provide a high level signal as the first trigger signal.

An overcurrent shutdown signal is generated based on the first trigger signal. For example, both input terminals of a third NAND gate circuit in the gate combination circuit receive the first trigger signal, so as to provide a low level signal as the overcurrent shutdown signal.

The compressor controller is shut down based on the overcurrent shutdown signal. For example, a switch control module may receive the overcurrent shutdown signal, such that a switch module is not turned on, so as to disconnect the power supply from the compressor controller.

A first setting signal is generated, and the overcurrent shutdown signal is locked based on the first setting signal and the first trigger signal, such that the compressor controller is able to be kept shut down. For example, one of input terminals of a second NAND gate circuit in the gate combination circuit receives the first setting signal as a high level signal and the other input terminal receives the first trigger signal, such that it can output a low level signal, so that the output of the third NAND gate is locked as an overcurrent shutdown signal to implement continuous shutdown.

Additionally or alternatively, the overcurrent protection method according to the second aspect of the present disclosure further includes, for example, the following restart steps (referring to FIG. 6).

The refrigerator is completely powered off and then powered on again. For example, the refrigerator may be unplugged and then plugged again into a socket.

A second setting signal is generated. For example, when the refrigerator is powered on again, a capacitor in a setting module will be first charged, so that a low level signal may be provided to one of the input terminals of the second NAND gate circuit in the gate combination circuit as a second setting signal.

When the compressor controller is in a shutdown state, an operation determining signal is generated when it is able to determine by comparison that the reference voltage is greater than the sampling voltage. For example, in the shutdown state, the sampling voltage may be considered as zero to some extent, and the comparator circuit can determine by comparison that the reference voltage is greater than the sampling voltage, so as to generate/output a high level signal as an operation determining signal.

A second trigger signal is generated based on the second setting signal and the operation determining signal. For example, one of the input terminals of the first NAND gate circuit in the gate combination circuit receives the high level signal outputted by the second NAND gate circuit based on the second setting signal, and the other input terminal receives the operation determining signal, so as to output a low level signal as the second trigger signal.

The lock on the output of the overcurrent shutdown signal is released based on the second trigger signal, so as to output an operation conduction signal. For example, both input terminals of the third NAND gate circuit in the gate combination circuit receive the second trigger signal, so as to output a high level signal as the operation conduction signal.

The operation of the compressor controller is restored based on the operation conduction signal. For example, the switch control module may receive the operation conduction signal, such that the switch module is turned on, so as to restore the connection between the power supply and the compressor controller.

The setting module changes to generating a first setting signal after the compressor controller is restarted. For example, after the restart and the completion of the charging process of the capacitor, a high level signal may be provided to one of the input terminals of the second NAND gate circuit as the first setting signal.

Additionally or alternatively, the overcurrent protection method according to the second aspect of the present disclosure further includes, for example, the following automatic restart steps (referring to FIG. 7).

An overcurrent shutdown signal is detected and the signal has been outputted for a period of time. This indicates that the compressor controller and the refrigerator have not been operated for a specific period of time.

A restart control signal is generated. For example, the automatic restart control module in the circuit may provide a low level signal to one of the input terminals of the second NAND gate circuit in the gate combination circuit as the restart control signal.

When the compressor controller is in a shutdown state, an operation determining signal is outputted when it is able to determine by comparison that the reference voltage is greater than the sampling voltage. For example, in the shutdown state, the sampling voltage may be considered as zero to some extent, and the comparator circuit can determine by comparison that the reference voltage is greater than the sampling voltage, so as to generate/output a high level signal as an operation determining signal.

A second trigger signal is generated based on the restart control signal and the operation determining signal. For example, one of the input terminals of the first NAND gate circuit in the gate combination circuit receives the high level signal outputted by the second NAND gate circuit based on the restart control signal, and the other terminal receives the operation determining signal, so as to output a low level signal as the second trigger signal.

The lock on the output of the overcurrent shutdown signal is released based on the second trigger signal, so as to output an operation conduction signal. For example, both input terminals of the third NAND gate circuit in the gate combination circuit receive the second trigger signal, so as to output a high level signal as the operation conduction signal.

The operation of the compressor controller is restored based on the operation conduction signal. For example, the switch control module may receive the operation conduction signal, such that the switch module is turned on, so as to restore the connection between the power supply and the compressor controller.

The setting module changes to continuing to generate a first setting signal after the compressor controller is restarted. For example, after the restart, a high level signal may be provided to one of the input terminals of the second NAND gate circuit as the first setting signal.

In the description of the present disclosure, it should be understood that, the terms “first”, “second”, and “third” are used for descriptive purposes only, and should not be construed as indicating or implying the relative importance. Therefore, the features defined with “first”, “second”, and “third” can explicitly or implicitly include one or more of the features.

Although the embodiments of the present disclosure have been shown and described above, it can be understood that the above embodiments are merely exemplary and should not be construed as limiting the present disclosure. Those of ordinary skill in the art may make combinations, changes, modifications, replacements, and variations to the above embodiments within the scope of the present disclosure.

1. An overcurrent protection circuit, wherein a power supply is connected to a compressor controller of a refrigerator via the overcurrent protection circuit, wherein the overcurrent protection circuit comprises:
a switch module configured to disconnect the power supply from and connect the power supply to the compressor controller;
a sampling module that samples a current flowing through the compressor controller and converts the current into a sampling voltage;
a reference module that provides a reference voltage to set an overcurrent protection threshold;
a determining module that compares the sampling voltage with the reference voltage, wherein when it is determined that the sampling voltage is greater than the reference voltage, a determining signal outputted by the determining module transitions to an overcurrent determining signal;
a determining signal control module that includes a trigger element and a switch element, wherein the trigger element receives the overcurrent determining signal and generates a first trigger signal based on the overcurrent determining signal, and the switch element receives the first trigger signal and generates an overcurrent shutdown signal based on the first trigger signal, wherein the determining signal control module further comprises a signal control element;
a switch control module that controls, based on the overcurrent shutdown signal, the switch module to disconnect the power supply from the compressor controller; and
a setting module that provides a first setting signal, wherein the signal control element locks the overcurrent shutdown signal based on the first setting signal and the first trigger signal, such that the power supply is able to be kept disconnected from the compressor controller, so as to shut down the compressor controller.

2. The overcurrent protection circuit according to claim 1, wherein when the compressor controller requires to be restarted:
the refrigerator is completely powered off and then powered on again;
the setting module provides a second setting signal;
the determining module is able to determine, when the compressor controller is in a shutdown state, that the reference voltage is greater than the sampling voltage, and the determining module outputs an operation determining signal,
wherein the signal control element cooperates, based on the second setting signal, with the trigger element that receives the operation determining signal, such that the trigger element generates a second trigger signal, the switch element receives the second trigger signal and releases, based on the second trigger signal, the lock on the output of the overcurrent shutdown signal, so as to output an operation conduction signal, and the switch control module controls, based on the operation conduction signal, the switch module to connect the power supply to the compressor controller, so as to restore the operation of the compressor controller; and
after the compressor controller is restarted, the setting module changes to providing a first setting signal.

3. The overcurrent protection circuit according to claim 1, wherein the overcurrent protection circuit further comprises an automatic restart control module, the automatic restart control module comprises a first port and a second port, and the first port detects output of the switch element, wherein when the first port detects an overcurrent shutdown signal outputted by the switch element and the signal has been outputted for a period of time:
the second port of the automatic restart control module is able to provide a restart control signal;
the determining module is able to determine, when the compressor controller is in a shutdown state, that the reference voltage is greater than the sampling voltage, and the determining module outputs an operation determining signal,
wherein the signal control element cooperates, based on the restart control signal, with the trigger element that receives the operation determining signal, such that the trigger element generates a second trigger signal, the switch element receives the second trigger signal and releases, based on the second trigger signal, the lock on the output of the overcurrent shutdown signal, so as to output an operation conduction signal, and the switch control module controls, based on the operation conduction signal, the switch module to connect the power supply to the compressor controller, so as to restore the operation of the compressor controller; and
after the compressor controller is restarted, the second port of the automatic restart control module causes the setting module to continue to provide a first setting signal.

4. The overcurrent protection circuit according to claim 1, wherein the determining signal control module is a gate combination circuit, wherein the trigger element is a first NAND gate circuit, the signal control element is a second NAND gate circuit, and the switch element is a third NAND gate circuit, wherein a second input terminal of the first NAND gate circuit is connected to an output terminal of the determining module as an input terminal of the determining signal control module, and a first input terminal of the first NAND gate circuit is connected to an output terminal of the second NAND gate circuit; a second input terminal of the second NAND gate circuit is connected to an output terminal of the first NAND gate circuit, and a first input terminal of the second NAND gate circuit is connected to the setting module; and a first input terminal and a second input terminal of the third NAND gate circuit are both connected to the output terminal of the first NAND gate circuit, and an output terminal of the third NAND gate circuit is used as an output terminal of the determining signal control module.

5. The overcurrent protection circuit according to any claim 1, wherein the setting module comprises a first voltage dividing resistor and a capacitor that are connected in series, wherein one terminal of the first voltage dividing resistor is connected to a positive electrode of the power supply, one terminal of the capacitor is connected to a negative electrode of the power supply, and a common connection terminal of the first voltage dividing resistor and the capacitor is connected to the signal control element.

6. The overcurrent protection circuit according to claim 1, wherein the switch module is an N-MOSFET, and the sampling module is a current sampling resistor, wherein a drain of the N-MOSFET is connected to a power supply negative electrode input terminal of the compressor controller, a source of the N-MOSFET is connected to one terminal of the current sampling resistor, and a gate of the N-MOSFET is connected to the switch control module, wherein the other terminal of the current sampling resistor is connected to a negative electrode of the power supply;
the reference module comprises a second voltage dividing resistor and a third voltage dividing resistor that are connected in series, wherein one terminal of the first voltage dividing resistor is connected to a positive electrode of the power supply, and one terminal of the second voltage dividing resistor is connected to the negative electrode of the power supply; and
the determining module is a comparator circuit, wherein a positive input terminal of the comparator circuit is connected to a common connection terminal of the first voltage dividing resistor and the second voltage dividing resistor, and a negative input terminal of the comparator circuit is connected to a common connection terminal of the N-MOSFET and the current sampling resistor.

7. The overcurrent protection circuit according to claim 6, wherein the switch control module comprises a first NPN transistor and a second NPN transistor, wherein a base of the first NPN transistor is connected to an output terminal of the determining signal control module, a collector of the first NPN transistor is connected to the positive electrode of the power supply via a pull-up resistor, and an emitter of the first NPN transistor is connected to the negative electrode of the power supply; and a base of the second NPN transistor is connected to the collector of the first NPN transistor, a collector of the second NPN transistor is connected to the positive electrode of the power supply via a pull-up resistor, and an emitter of the second NPN transistor is connected to the negative electrode of the power supply, wherein the collector of the second NPN transistor is connected to a gate of the switch module.

8. The overcurrent protection circuit according to claim 6, wherein the switch control module comprises a first NPN transistor and a second PNP transistor, wherein a base of the first NPN transistor is connected to an output terminal of the determining signal control module, a collector of the first NPN transistor is connected to the positive electrode of the power supply via a pull-up resistor, and an emitter of the first NPN transistor is connected to the negative electrode of the power supply; and a base of the second PNP transistor is connected to the collector of the first NPN transistor, an emitter of the second PNP transistor is connected to the positive electrode of the power supply, and a collector of the second PNP transistor is connected to a gate of the switch module via a current limiting resistor.

9. The overcurrent protection circuit according to claim 1, wherein the switch module comprises a P-MOSFET, wherein a source of the P-MOSFET is connected to a positive electrode of the power supply, a drain of the P-MOSFET is connected to a power supply positive electrode input terminal of the compressor controller, and a gate of the P-MOSFET is connected to the switch control module;
the sampling module is a current sampling resistor connected between a power supply negative electrode input terminal of the compressor controller and a negative electrode of the power supply;
the reference module comprises a second voltage dividing resistor and a third voltage dividing resistor that are connected in series, wherein one terminal of the second voltage dividing resistor is connected to a positive electrode of the power supply, and one terminal of the third voltage dividing resistor is connected to the negative electrode of the power supply; and
the determining module is a comparator circuit, wherein a positive input terminal of the comparator circuit is connected to a common connection terminal of the second voltage dividing resistor and the third voltage dividing resistor, and a negative input terminal of the comparator circuit is connected between the current sampling resistor and the power supply negative electrode input terminal of the compressor controller.

10. The overcurrent protection circuit according to claim 9, wherein the switch module comprises a first NPN transistor, a base of the first NPN transistor is connected to an output terminal of the determining signal control module, a collector of the first NPN transistor is connected to a gate of the switch module via a current limiting resistor, an emitter of the first NPN transistor is connected to a negative electrode of the power supply, and the gate of the switch module is connected to the positive electrode of the power supply via a current limiting resistor.

11. An overcurrent protection method for protecting a compressor controller of a refrigerator, comprising the following steps:
sampling a current flowing through the compressor controller and converting the current into a sampling voltage;
comparing the sampling voltage with an overcurrent protection threshold, and generating an overcurrent determining signal when the sampling voltage is greater than the overcurrent protection threshold;
generating a first trigger signal based on the overcurrent determining signal;
generating an overcurrent shutdown signal based on the first trigger signal;
shutting down the compressor controller based on the overcurrent shutdown signal; and
generating a first setting signal, and locking the overcurrent shutdown signal based on the first setting signal and the first trigger signal, such that the compressor controller is able to be kept shut down.

12. The overcurrent protection method according to claim 11, wherein when the compressor controller requires to be restarted, the method comprises the following steps:
powering off the refrigerator completely and then powering it on again;
generating a second setting signal;
when the compressor controller is in a shutdown state, generating an operation determining signal when it is able to determine by comparison that the reference voltage is greater than the sampling voltage;
generating a second trigger signal based on the second setting signal and the operation determining signal;
releasing the lock on the output of the overcurrent shutdown signal based on the second trigger signal, so as to output an operation conduction signal;
restoring the operation of the compressor controller based on the operation conduction signal; and
changing to generating a first setting signal after the compressor controller is restarted.

13. The overcurrent protection method according to claim 11, further comprising the following steps:
detecting an overcurrent shutdown signal and that the signal has been outputted for a period of time;
generating a restart control signal;
when the compressor controller is in a shutdown state, outputting an operation determining signal when it is able to determine by comparison that the reference voltage is greater than the sampling voltage;
generating a second trigger signal based on the restart control signal and the operation determining signal;
releasing the lock on the output of the overcurrent shutdown signal based on the second trigger signal, so as to output an operation conduction signal;
restoring the operation of the compressor controller based on the operation conduction signal; and
changing to continuing to generate a first setting signal after the compressor controller is restarted.
